(19) United States
(12) Patent Application Publication
(10) Pub. No.: US 2011/0176765 A1
(43) Pub. Date: Jul. 21, 2011

(54) OPTICAL INTERCONNECTION APPARATUS AND METHOD

(76) Inventor: Yong Tak Lee, Gwangju (KR)

(21) Appl. No.: 13/121,409

(22) PCT Filed: Sep. 29, 2009
(86) PCT No.: PCT/KR09/05552

§ 371 Date: Mar. 28, 2011

(30) Foreign Application Priority Data
Sep. 30, 2008 (KR) 10-2008-0096319

(51) Int. Cl. G02B 6/12; G02B 6/36

(52) U.S. Cl. 385/14; 29/825

(57) ABSTRACT

The present invention relates to the apparatus and method for optical interconnection. The present invention provides an optical interconnection structure comprising: a substrate on which double side perforated multi-hole through a predetermined region is formed; bottom hole which is etched and tapered for optical fiber array is bigger than upper hole which is etched for the optical devices. The present invention provides the optical interconnection structure that can facilitate the optical interconnection between the active optoelectronic devices that transmit/receive the optical signals and the optical fiber array, making it possible to align easily and acutely between the optical devices and optical fiber array.

### FIELD OF THE INVENTION

The present invention relates to the apparatus and method for optical interconnection, and more particulraly, to an optical interconnection structure that double side perforated multi-hole through a predetermined region.

### DESCRIPTION OF THE RELATED ART

Optical active cable generally used to send optical signal such as DVI (Digital Visual Interface). Optical interconnection apparatus used to fix between the optical fiber array and optical device.

This optical fiber apparatus is known for optical fiber connector. It connects optical fiber and optical device by the reticular shape body. For example, this optical interconnection apparatus is posted on 2008-46047 in Korea intellectual property office.

Optical fiber connector has two entrances; one is for the optical devices and the other is for the optical fiber. Therefore, optical devices and optical fiber is aligned by inserting into the optical connector.

Entrances for optical fiber holder and optical devices correspond to optical fiber and optical devices diameter. Therefore, optical devices and optical fiber holder are aligned by inserting into the optical connector.

However, problems arise in that if optical connector has some misalignment, there is nothing to compensate between the optical devices and optical fiber. In other words, due to optical devices and optical fiber are aligned by inserting into the optical fiber connector, if optical connector has some misalignment; there is nothing to compensate.

In addition, it is necessary additional optical connector to hold optical device and optical fiber.

### SUMMARY OF THE INVENTION

The present invention provides the optical interconnection structure that can facilitate the optical interconnection between the active optoelectronic devices that transmit/receive the optical signals and the optical fiber array, making it possible to align easily and acutely between the optical devices and optical fiber array.

In order to solve the above problems, it is an object of the present invention to provide an optical interconnection structure that aligns between the optical devices and optical fiber array on the same axis easily by using perforated hole. Tapered hole make it possible to delicate control to the optical fiber array in an inserted state. Therefore, it can accurately align between the optical fiber core and optical devices.

It is another object of the present invention to provide an optical interconnection structure that can be manufactured in great quantities and remarkably improved in view of yield by allowing the semiconductor process at a wafer level to be performed during the processes for forming double side perforated hole on the substrate.

In order to accomplish the objects, according to a first aspect of the present invention, there is provided an optical interconnection structure comprising: a substrate on which double side perforated multi-hole through a predetermined region is formed, the perforated multi-hole includes bottom hole which is etched and tapered for optical fiber array, in that the inner surface thereof is tilted and the entrance thereof is bigger than bottom surface, to make delicate control to the optical fiber array in an inserted state; and upper hole which is etched for the optical devices which are bonded on the substrate.

Preferably, the end point of the optical fiber array is located in n the boundary between bottom surface and the inner surface.

The substrate may be formed by a epoxy PCB, metal PCB, silicon PCB and glass PCB (printed circuit board) material and etched by deep trench RIE (reactive ion etcher system), electro chemical drill or femto-second laser process.

The optical interconnection structure preferably includes an optical fiber array; epoxy filled between the inner surface of the bottom hole and the optical fiber array 30; an optical device which is located to be aligned with the optical fiber array through the upper hole.

According to a second aspect of the present invention, there is provided a method for optical interconnection comprising: (a) forming the perforated multi-hole on double side of substrate in a predetermined region, the perforated multi-hole including bottom hole which is etched and tapered for optical fiber array, in that the inner surface thereof is tilted and the entrance thereof is bigger than bottom surface; (b) attaching an optical device on the substrate by flip chip bonding; (c) aligning an optical fiber array to the optical device through the perforated hole; (d) filling epoxy between the bottom hole and optical fiber array; and (e) exposing UV light.

Preferably, the substrate includes the electrical line pattern and the optical device is bonding by flip chip.

According to the present invention, there is provided an optical interconnection structure including: a substrate is made by metal, silicon and glass PCB (printed circuit board). Optical fiber array is aligned on the same axis by the perforated hole. Tapered hole can lead the optical fiber array to easily align. Optical devices such as laser diode and photodiode are attached by flip chip bonding on the substrate.

### BRIEF DESCRIPTION OF THE DRAWINGS

FIG. 1 explains an optical interconnection structure according to an embodiment of the present invention; and

FIG. 2 is a cross-sectional view explaining an optical interconnection structure according to an embodiment of the present invention.

FIG. 3 explains a method for manufacturing an optical interconnection structure according to an embodiment of the present invention.

### DETAILED DESCRIPTION OF THE PREFERRED EMBODIMENTS

Hereinafter, the embodiments of the present invention will be described in detail with reference to the accompanying drawings. However, the embodiments of the present invention may be modified in various shapes and the scope of the present invention is not limited to the embodiments set forth below. The embodiments of the present invention are provided for more completely explaining the present invention to those skilled in the art.

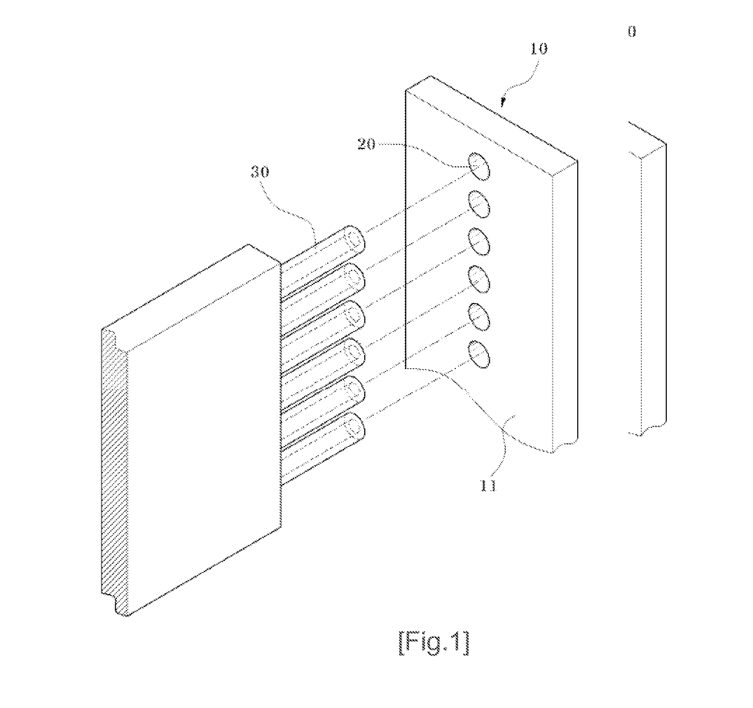

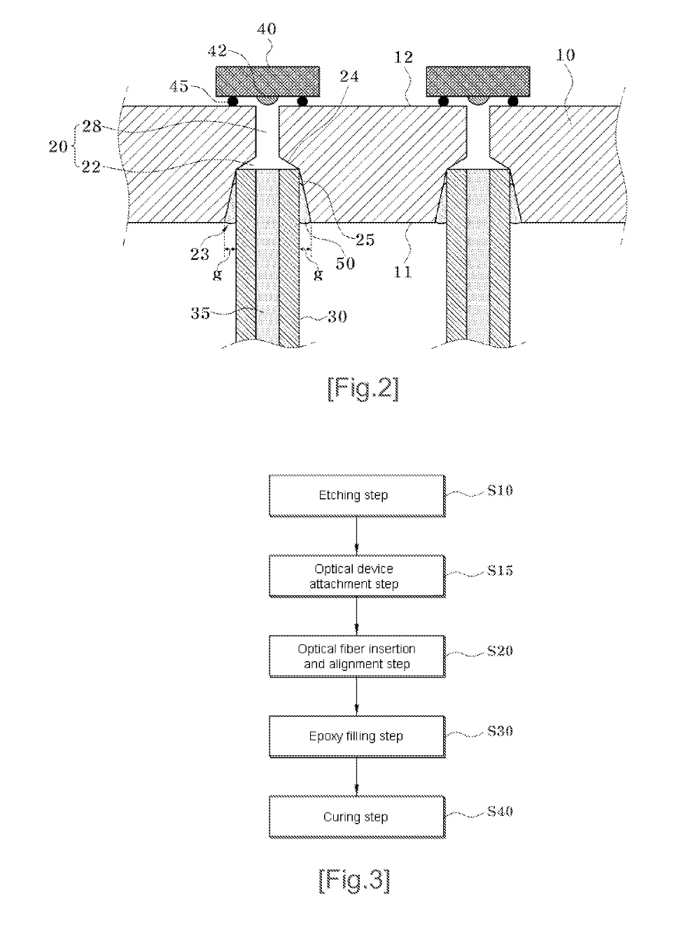

FIG. 1 explains an optical interconnection structure according to an embodiment of the present invention. FIG. 2 is a cross-sectional view explaining an optical interconnection structure according to an embodiment of the present invention.

The optical interconnection structure of FIG. 1 includes bottom hole 22 of optical fiber insertion, upper hole 28 of optical path and a substrate 10 on which multi-hole 20 perforating through a predetermined region is formed. Each optical fiber array 30 and each optical device 40 can be aligned through the perforated hole 20 of a substrate 10.

The substrate 10 preferably is formed by a metal, silicon or glass PCB (printed circuit board) material. According to the present invention, optical interconnection structure is formed by optical interconnection substrate 10 such as PCB. Therefore, optical devices 40 such as laser diode or photo diode can be packaged on the PCB substrate which is electrical patterned. Therefore, optical devices 40 can be easily connected with the optical interconnection structure which has electrical pattern. Therefore, additional process is not needed to connect with the optical interconnection structure.

A substrate 10 on which double side perforated multi-hole 20 through a predetermined region is formed. Each perforated multi-hole 20 include bottom hole 22 of optical fiber and upper hole 28 of optical path.

Bottom hole 22 is etched to allow the optical fiber to insert on the PCB substrate 10. Bottom hole 22 is etched about 200˜300 um by deep trench RIE (reactive ion etcher system), electro chemical drill or femto-second laser process. The bottom hole 22 has a tapered shape with cone shape. In the bottom hole 22, the inner surface 25 thereof is tilted and the entrance thereof is bigger than bottom surface 24. The inner surface 25 can lead the optical fiber array 30 to easily align. Due to the bottom hole 22 which is tapered for optical fiber array is bigger than the upper hole 28, it is possible to make delicate control to the optical fiber array 30 in an inserted state. Therefore, controlling the optical fiber array 30, it can accurately align between the optical fiber core 35 and optical devices 40. In the boundary between bottom surface 24 and the inner surface 25, the end point of the optical fiber array 30 is located. The entrance 23 of the bottom hole 22 is bigger than bottom surface 24. The bottom surface 24 and the inner surface 25 have taper shapes which is similar to cone shape. This is why it can accurately align between the optical fiber core 35 and optical devices 40.

There are about 20˜100 um gap (g) between the entrance 23 of the bottom hole 22 and optical fiber array 30.

To cope with the optical fiber core, the upper hole 28 size is smaller than the bottom hole 22 size.

Upper hole 28 provides the optical path which light pass though the optical fiber core and etched height is about 150 um.

Perforated hole 20 on the PCB substrate 10 is fabricated by etching process. In the case of wiring pattern is designed on the PCB substrate 10, wiring pattern and perforated hole 20 can be formed by etching process. Therefore, perforated hole 20 can be made without additional micro fabrication.

The embodiments of the present invention includes optical fiber array 30 which is connected with perforated hole 20 on the substrate 10 and optical devices 40.

Optical fiber array 30 is aligned on the same axis by the perforated hole 20. The inner surface 25 can lead the optical fiber array 30 to easily align. Due to the bottom hole 22 which is tapered for optical fiber array is bigger than the upper hole 28, it is possible to make delicate control to the optical fiber array 30 in an inserted state. Therefore, controlling the optical fiber array 30, it can accurately align between the optical fiber core and optical devices.

Optical devices 40 are packaged on the PCB substrate 10. There are several methods to bond between optical devices 40 and the substrate 10 such as flip chip bonding or wire boding. However, in the case of micro-lens 42 integrated optical devices 40 such as laser diode and photodiode, flip chip bonding is more preferred. The flip chip bonding height 45 is about 20 um. Microlens is aligned by the optical path hole 28.

Optical fiber array 30 is fixed by inserting it into the bottom hole 22. The inner surface 25 can lead the optical fiber array 30 to easily align. Due to the bottom hole 22 which is tapered for optical fiber array is bigger than the upper hole 28, it is possible to make delicate control to the optical fiber array 30 in an inserted state. Therefore, controlling the optical fiber array 30, it can accurately align between the optical fiber core 35 and optical devices 40.

Epoxy 50 is filled between the inner surface 25 and optical fiber array 30 and then UV light is exposed to cure. Therefore, optical fiber array 30 is fixed on the substrate 10.

FIG. 3 explains a method for manufacturing an optical interconnection structure according to an embodiment of the present invention. The substrate 10 preferably is formed by a metal, silicon or glass PCB (printed circuit board) material.

A substrate 10 on which double side perforated multi-hole through a predetermined region is formed (S10).

Perforated hole 20 consists of bottom hole 22 for optical fiber array insertion and upper hole 28 for optical path. Perforated hole 20 is formed by etching process, and the bottom hole 22 is tapered.

Etching process S10 includes the optical interconnection surface 12, if necessary, wiring pattern can be formed other surface. These kinds of wiring pattern can be used for electrical connection between optical devices 40 or between optical interconnection substrate 10.

Alignment step S20, optical fiber array 30 is aligned on the same axis by inserting into the perforated hole. Epoxy 50 is filled S30 between the inner surface 25 and optical fiber array 30 and UV light is exposed S40 to cure.

Epoxy 50 can be substituted of other materials which have the similar characteristics. These kinds of materials are treated the same as epoxy.

The embodiments of the present invention include optical devices 40 attachment S15 on the substrate 10. Before or after the optical fiber array insertion, optical devices attachment can be done. Desirable, optical devices are attached before the optical fiber array insertion.

What is claimed is:

1. An optical interconnection structure comprising:
a substrate on which double side perforated multi-hole through a predetermined region is formed,
the perforated multi-hole including bottom hole which is etched and tapered for optical fiber array, in that the inner surface thereof is tilted and the entrance thereof is bigger than bottom surface, to make delicate control to the optical fiber array in an inserted state; and upper hole which is etched for the optical devices which are bonded on the substrate.

2. The optical interconnection structure according to claim 1, the bottom hole is tapered with cone shape.

3. The optical interconnection structure according to claim 2, wherein the end point of the optical fiber array is located in n the boundary between bottom surface and the inner surface.

4. The optical interconnection structure according to claim 1 or 2, wherein the substrate is formed by a epoxy PCB, metal PCB, silicon PCB and glass PCB (printed circuit board) material and etched by deep trench RIE (reactive ion etcher system), electro chemical drill or femto-second laser process.

5. The optical interconnection structure according to claim 1 or 2, wherein the optical interconnection structure includes an optical fiber array; epoxy filled between the inner surface of the bottom hole and the optical fiber array 30; an optical device which is located to be aligned with the optical fiber array through the upper hole.

6. The optical interconnection structure according to claim 5, wherein the cal device is laser diode or photodiode.

7. A method for optical interconnection comprising:
forming the perforated multi-hole on double side of substrate in a predetermined region, the perforated multi-hole including bottom hole which is etched and tapered for optical fiber array, in that the inner surface thereof is tilted and the entrance thereof is bigger than bottom surface;
attaching an optical device on the substrate by flip chip bonding;
aligning an optical fiber array to the optical device through the perforated hole;
filling epoxy between the bottom hole and optical fiber array; and
exposing UV light.

8. A method for optical interconnection according to claim 7, wherein the bottom hole is tapered for guiding the optical fiber array.

9. A method for optical interconnection according to claim 7, wherein the substrate includes the electrical line pattern.

10. A method for optical interconnection according to claim 7 or 9, wherein the optical device is bonding by flip chip.
